(19) United States
(12) Patent Application Publication
(10) Pub. No.: US 2022/0026544 A1
(43) Pub. Date: Jan. 27, 2022

(54) Ranging Method, Apparatus, and Device

(71) Applicant: Huawei Technologies Co., Ltd., Shenzhen (CN)

(72) Inventors: Hongying Wu, Beijing (CN); Tong Jiang, Beijing (CN); Qiang Li, Beijing (CN); Honglei Li, Beijing (CN)

(21) Appl. No.: 17/496,999

(22) Filed: Oct. 8, 2021

Related U.S. Application Data
(63) Continuation of application No. PCT/CN2019/081876, filed on Apr. 9, 2019.

(51) Int. Cl. G01S 7/4865; G01S 17/08; G01S 7/48

(52) U.S. Cl. CPC G01S 7/4865; G01S 7/4808; G01S 17/08

(57) ABSTRACT

A ranging method includes obtaining a first echo signal that is obtained after laser light emitted by a laser to a measured object is reflected by the measured object, determining that the first echo signal is a saturated echo signal, calculating an initial distance using a receiving moment of the first echo signal, determining a target distance compensation value corresponding to a saturation degree of the first echo signal, compensating, using the target distance compensation value and in a distance compensation manner, the initial distance, and setting a distance obtained after compensation as a measured distance between the measured object and the laser.

### CROSS-REFERENCE TO RELATED APPLICATIONS

This is a continuation of International Patent Application No. PCT/CN2019/081876 filed on Apr. 9, 2019, which is hereby incorporated by reference in its entirety.

### TECHNICAL FIELD

This application relates to ranging technologies, and in particular, to a ranging method, apparatus, and device.

### BACKGROUND

A laser ranging technology has a wide application prospect in the fields of autonomous driving, atmospheric environment monitoring, geographic mapping, drones, and the like. The laser ranging technology is an optical remote sensing technology in which electromagnetic waves from an ultraviolet band to a far infrared band are used to detect characteristics of reflected light that is reflected by a measured object, to obtain related information of the measured object.

In the laser ranging technology, pulse-type laser ranging based on time of flight (ToF) is mainly utilized, and its basic principle is as follows. A laser emits a laser pulse to a measured object, the laser pulse is reflected back after reaching the measured object, a difference between an emission moment of the laser pulse and a receiving moment of the laser pulse is recorded, and then a distance between the laser and the measured object is calculated by using the formula R=ct/2n. In the formula, R is the distance between the laser and the measured object, c is a propagation speed of the light in the air, and is about 299,792,458 meters per second (m/s), n is a refractive index of the light in a propagation medium, and t is the difference between the emission moment of the laser pulse and the receiving moment of the laser pulse.

It may be understood that, if the emission moment of the laser pulse and the receiving moment of the laser pulse can be determined, the distance between the laser and the measured object can be calculated by using the foregoing formula. A received laser signal may be converted into an electrical signal such as a voltage, and then a receiving moment of an echo signal is determined by using a characteristic, for example, an amplitude value, of the electrical signal such as the voltage. However, for a common laser ranging system, when a requirement of long-distance ranging is met, a case in which an echo signal is saturated usually occurs in a process of measuring a short distance. For understanding, refer to FIG. 1A and FIG. 1B. In FIGS. 1A and 1B, the horizontal coordinate indicates time, and the vertical coordinate indicates voltage. FIG. 1A shows an unsaturated echo signal, and FIG. 1B shows a saturated echo signal. Once an echo signal is saturated, a waveform “clipped” case shown in FIG. 1B occurs. To be specific, the saturated echo signal cannot indicate complete electrical signal characteristics of a laser pulse because an actual amplitude value of a clipped part of the waveform cannot be determined. Consequently, a receiving moment, of the echo signal, obtained by using a characteristic, for example, an amplitude value, of a voltage of the echo signal is inaccurate, and further, a ranging result is inaccurate.

### SUMMARY

According to a first aspect, embodiments of this application provide a ranging method, apparatus, and device, to accurately determine a distance between a measured object and a laser when a first echo signal is saturated. Further, a first echo signal that is obtained after laser light emitted by the laser to the measured object is reflected by the measured object may be obtained. When the first echo signal is a saturated echo signal, it is considered that an initial distance that is between the measured object and the laser and that is obtained through calculation based on a receiving moment of the first echo signal may be inaccurate. Therefore, the foregoing initial distance is compensated in a distance compensation manner, and a distance obtained after compensation is used as a measured distance between the measured object and the laser. During actual application, ranging errors corresponding to the foregoing initial distance are different when saturation degrees of the first echo signal are different. Therefore, in the embodiments of this application, a target distance compensation value corresponding to a saturation degree may be determined based on the saturation degree of the first echo signal. In addition, the target distance compensation value is used to compensate the initial distance, to obtain the measured distance between the measured object and the laser. It can be learned that, according to the solutions in the embodiments of this application, the target distance compensation value suitable for the first echo signal may be determined based on the saturation degree of the first echo signal, to accurately determine the measured distance between the measured object and the laser.

In an implementation of the embodiments of this application, it is considered, when the first echo signal is the saturated echo signal, the receiving moment of the first echo signal cannot be accurately determined by using a conventional manner of determining the first echo signal. Consequently, a ranging error corresponding to the initial distance that is obtained through calculation by using the receiving moment is relatively large. Therefore, in an implementation of the embodiments of this application, a new method is introduced and is used to accurately determine the receiving moment of the first echo signal, to reduce the ranging error corresponding to the foregoing initial distance. Further, it may be determined one or two corresponding moments at which an amplitude value is a first threshold. In addition, an earlier moment of the two moments is determined as the receiving moment of the first echo signal, or the one moment is determined as the receiving moment of the first echo signal.

In an implementation of the embodiments of this application, when the first echo signal is a digital signal, and because the digital signal is discrete sampling points, in these discrete sampling points, a sampling point whose amplitude value is the first threshold does not necessarily exist. Because a sampling rate of a laser ranging system is relatively low, a time difference between two adjacent sampling points in the first echo signal is relatively large. In this case, a correspondingly determined receiving moment may also have a relatively large error. In the embodiments of this application, when the first echo signal is a digital signal, to improve a virtual sampling rate to reduce hardware implementation costs, and further to accurately determine the receiving moment of the first echo signal, the receiving moment of the first echo signal may be determined in a manner of calculating a rising edge equation. Further, a corresponding rising edge equation is fitted based on a partial echo signal in the first echo signal, where an independent variable of the rising edge equation is time, a dependent variable is amplitude, and the partial echo signal is an echo signal whose amplitude value increases as time increases, and according to the rising edge equation, a corresponding moment at which the amplitude value is the first threshold is determined as the receiving moment of the first echo signal.

In an implementation of the embodiments of this application, a correspondence between the saturation degree and a distance compensation value may be predetermined. Further, a laser may be used to emit a plurality of laser pulses to a calibration object, where an actual distance between the calibration object and the laser is known. Then, a plurality of calibration echo signals are obtained, where the plurality of calibration echo signals are obtained by converting a plurality of laser signals that are reflected back by the calibration object, all the plurality of calibration echo signals are digital signals, and each of the plurality of calibration echo signals corresponds to one saturation degree. A rising edge equation of each of the plurality of calibration echo signals is calculated by using the foregoing method of calculating the rising edge equation, and according to the rising edge equation corresponding to each of the plurality of calibration echo signals, a corresponding moment at which an amplitude value of each of the plurality of calibration echo signals is equal to the first threshold is determined as a receiving moment of each of the plurality of calibration echo signals. Subsequently, differences between a known actual distance between the calibration object and the laser and the plurality of calculated distances are separately calculated, to obtain a plurality of distance compensation values in calibration. Finally, the correspondence is determined based on each distance compensation value in the plurality of distance compensation values in calibration and a saturation degree corresponding to each distance compensation value.

In an implementation of the embodiments of this application, the first echo signal may be analyzed to obtain the saturation degree of the first echo signal. As described above, the first echo signal may be a digital signal. When the first echo signal is a digital signal, during specific implementation, the saturation degree of the first echo signal may be determined based on a quantity of saturated sampling points whose amplitude values are greater than or equal to a second threshold in the first echo signal. It may be understood that, generally, a higher saturation degree of the first echo signal indicates a larger quantity of corresponding saturated sampling points whose amplitude values are greater than or equal to the second threshold, and a lower saturation degree of the first echo signal indicates a smaller quantity of corresponding saturated sampling points whose amplitude values are greater than or equal to the second threshold.

In an implementation of the embodiments of this application, it is considered that generally, an amplitude value of a saturated echo signal is relatively large in practice. Therefore, in this embodiment of this application, whether the first echo signal is a saturated echo signal may be preliminarily determined based on the maximum amplitude value of the first echo signal. Further, when the maximum amplitude value of the first echo signal is greater than the second threshold, it may be considered that the amplitude value of the first echo signal is relatively large, and correspondingly, a possibility that the first echo signal is preliminarily determined as a saturated echo signal is relatively large. Then, considering that the saturated echo signal has a case such as a waveform “clipped” case or a pulse width broadening case, in the embodiments of this application, the quantity of saturated sampling points whose amplitude values are greater than or equal to the second threshold may be used to determine whether the first echo signal generates waveform “clipped” or pulse width broadening. If the quantity of saturated sampling points whose amplitude values are greater than or equal to the second threshold is greater than or equal to a preset quantity, it is determined that the first echo signal generates waveform “clipped” or pulse width broadening. Therefore, it may be determined that the first echo signal is the saturated echo signal.

In an implementation of the embodiments of this application, during specific implementation of calculating the initial distance, the receiving moment of the first echo signal and a transmitting moment of the first echo signal may be determined, based on the receiving moment of the first echo signal and the transmitting moment of the first echo signal, a first time of flight of the laser light emitted by the laser between the laser and the measured object is obtained, and the initial distance is obtained through calculation based on the first time of flight.

In an implementation of the embodiments of this application, during specific implementation of calculating the initial distance, the initial distance may be determined by using a reference object whose actual distance from the laser is known. Further, the receiving moment of the first echo signal and a receiving moment of a second echo signal may be determined. The second echo signal is an echo signal obtained after the laser light emitted by the laser to the measured object is reflected by the reference object. That is, when the distance between the measured object and the laser is measured, a laser beam emitted by the laser is reflected by not only the measured object, but also the reference object. In this case, a second time of flight of the laser light emitted by the laser between the measured object and the reference object may be obtained through calculation based on the receiving moment of the first echo signal and the receiving moment of the second echo signal, and then a distance between the measured object and the reference object is obtained through calculation based on the second time of flight. Because the actual distance between the laser and the reference object is known, the initial distance may be obtained through calculation with reference to the known actual distance between the reference object and the laser and the distance between the measured object and the reference object. Further, if the reference object is located between the measured object and the laser, a sum of the known actual distance between the reference object and the laser and the distance between the measured object and the reference object may be calculated, to obtain the initial distance. Alternatively, if the measured object is located between the reference object and the laser, a difference between the known actual distance between the reference object and the laser and the distance between the measured object and the reference object may be calculated, to obtain the initial distance.

According to a second aspect, an embodiment of this application provides a ranging apparatus. The apparatus includes a first obtaining unit configured to obtain a first echo signal that is obtained after laser light emitted by a laser to a measured object is reflected by the measured object, a first determining unit configured to, when the first echo signal is a saturated echo signal, determine a saturation degree of the first echo signal, a first calculation unit configured to calculate an initial distance based on a receiving moment of the first echo signal, where the initial distance is a distance between the measured object and the laser, a second determining unit configured to determine, based on a correspondence between the saturation degree and a distance compensation value, a target distance compensation value corresponding to the saturation degree of the first echo signal, and a compensation unit configured to compensate the initial distance by using the target distance compensation value, and use a distance obtained after compensation as a measured distance between the measured object and the laser.

In an implementation of this embodiment of this application, the apparatus further includes a third determining unit configured to determine one or two corresponding moments at which an amplitude value of the first echo signal is a first threshold, and determine an earlier moment of the two moments or the one moment as the receiving moment of the first echo signal. A part whose amplitude value is less than the first threshold in the first echo signal is noise.

In an implementation of this embodiment of this application, the first echo signal is a digital signal. The third determining unit is further configured to fit a corresponding rising edge equation based on a partial echo signal in the first echo signal, where an independent variable of the rising edge equation is time, a dependent variable is amplitude, and the partial echo signal is an echo signal whose amplitude value increases as time increases, and determine, according to the rising edge equation, a corresponding moment at which the amplitude value is the first threshold as the receiving moment of the first echo signal.

In an implementation of this embodiment of this application, the apparatus further includes a second obtaining unit configured to obtain a plurality of calibration echo signals, where each of the plurality of calibration echo signals corresponds to one saturation degree, the plurality of calibration echo signals are obtained after laser light emitted by the laser to a calibration object is reflected by the calibration object, and all the plurality of calibration echo signals are digital signals, a second calculation unit configured to calculate a corresponding rising edge equation for each of the plurality of calibration echo signals, a fourth determining unit configured to determine, according to the rising edge equation corresponding to each of the plurality of calibration echo signals, a corresponding moment at which an amplitude value of each of the plurality of calibration echo signals is the first threshold as a receiving moment of each of the plurality of calibration echo signals, a third calculation unit configured to calculate a distance between the calibration object and the laser by using the receiving moment of each of the plurality of calibration echo signals, to obtain a calculated distance corresponding to each of the plurality of calibration echo signals, a fourth calculation unit configured to separately calculate differences between a known actual distance between the calibration object and the laser and the plurality of calculated distances, to obtain a plurality of distance compensation values in calibration, and a fifth determining unit configured to determine the correspondence based on each distance compensation value in the plurality of distance compensation values in calibration and a saturation degree corresponding to each distance compensation value.

In an implementation of this embodiment of this application, the first echo signal includes a plurality of sampling points, and the determining a saturation degree of the first echo signal includes In the plurality of sampling points, the saturation degree of the first echo signal is determined based on a quantity of saturated sampling points whose amplitude values are greater than or equal to a second threshold in the first echo signal, where the saturation degree is positively correlated with the quantity of saturated sampling points, and an amplitude value corresponding to the second threshold is greater than an amplitude value corresponding to the first threshold.

In an implementation of this embodiment of this application, that the first echo signal is a saturated echo signal includes, when a maximum amplitude value of the first echo signal is greater than or equal to the second threshold, and the quantity of saturated sampling points whose amplitude values are greater than or equal to the second threshold in the first echo signal is greater than or equal to a preset quantity, the first echo signal is the saturated echo signal.

In an implementation of this embodiment of this application, the first calculation unit is further configured to obtain, based on the receiving moment of the first echo signal and a transmitting moment of the first echo signal, a first time of flight of the laser light emitted by the laser between the laser and the measured object, and obtain the initial distance through calculation based on the first time of flight.

In an implementation of this embodiment of this application, the first calculation unit is further configured to obtain, based on the receiving moment of the first echo signal and a receiving moment of a second echo signal, a second time of flight of the laser light emitted by the laser between the measured object and a reference object, where the second echo signal is an echo signal obtained after the laser light emitted by the laser to the reference object is reflected by the reference object, obtain a distance between the measured object and the reference object through calculation based on the second time of flight, and calculate a sum of a known actual distance between the reference object and the laser and the distance between the measured object and the reference object, to obtain the initial distance, or calculate a difference between a known actual distance between the reference object and the laser and the distance between the measured object and the reference object, to obtain the initial distance.

According to a third aspect, an embodiment of this application further provides a ranging device. The device includes a processor and a memory, where the memory is configured to store instructions, and the processor is configured to execute the instructions in the memory, to perform the method according to any one of the implementations of the first aspect.

According to a fourth aspect, an embodiment of this application provides a computer-readable storage medium, including instructions. When the instructions are run on a computer, the computer is enabled to perform the method according to any one of the implementations of the first aspect.

According to a fifth aspect, an embodiment of this application provides a computer program product including instructions. When the computer program product is run on a computer, the computer is enabled to perform the method according to any one of the implementations of the first aspect.

According to a sixth aspect, an embodiment of this application further provides a mobile platform. The mobile platform includes a laser, a receiver, and the ranging apparatus according to any one of the implementations of the second aspect. The laser is configured to emit laser light to a measured object, and the receiver is configured to receive an echo signal formed through reflection by the measured object.

### BRIEF DESCRIPTION OF DRAWINGS

FIG. 1A is a schematic diagram of an unsaturated echo signal according to an embodiment of this application;

FIG. 1B is a schematic diagram of a saturated echo signal according to an embodiment of this application;

FIG. 2 is a schematic structural diagram of an autonomous driving system according to an embodiment of this application;

FIG. 3 is a schematic flowchart of a ranging method according to an embodiment of this application;

FIG. 4 is a schematic flowchart of determining a receiving moment of a first echo signal according to an embodiment of this application;

FIG. 5 is a schematic diagram of a first echo signal according to an embodiment of this application;

FIG. 6A is a schematic diagram of first echo signals with different saturation degrees according to an embodiment of this application;

FIG. 6B is a schematic diagram of rising edge curves of first echo signals with different saturation degrees according to an embodiment of this application;

FIG. 7 is a schematic structural diagram of a ranging apparatus according to an embodiment of this application; and

FIG. 8 is a schematic structural diagram of a ranging device according to an embodiment of this application.

### DESCRIPTION OF EMBODIMENTS

The following clearly describes the technical solutions in the embodiments of this application with reference to the accompanying drawings in the embodiments of this application. It is clear that the described embodiments are merely some but not all of the embodiments of the present disclosure. All other embodiments obtained by persons skilled in the art based on the embodiments of the present disclosure shall fall within the protection scope of the present disclosure.

In the specification, claims, and accompanying drawings of this application, the terms “first”, “second”, “third”, “fourth”, and the like (if existent) are intended to distinguish between similar objects but do not necessarily indicate a specific order or sequence. It should be understood that the data termed in such a way are interchangeable in proper cases, so that the embodiments described herein can be implemented in other orders than the order illustrated or described herein. Moreover, the terms “include”, “contain”, and any other variants mean to cover the non-exclusive inclusion. For example, a process, method, system, product, or device that includes a series of steps or units is not necessarily limited to those expressly listed steps or units, but may include other steps or units not expressly listed or inherent to such a process, method, system, product, or device.

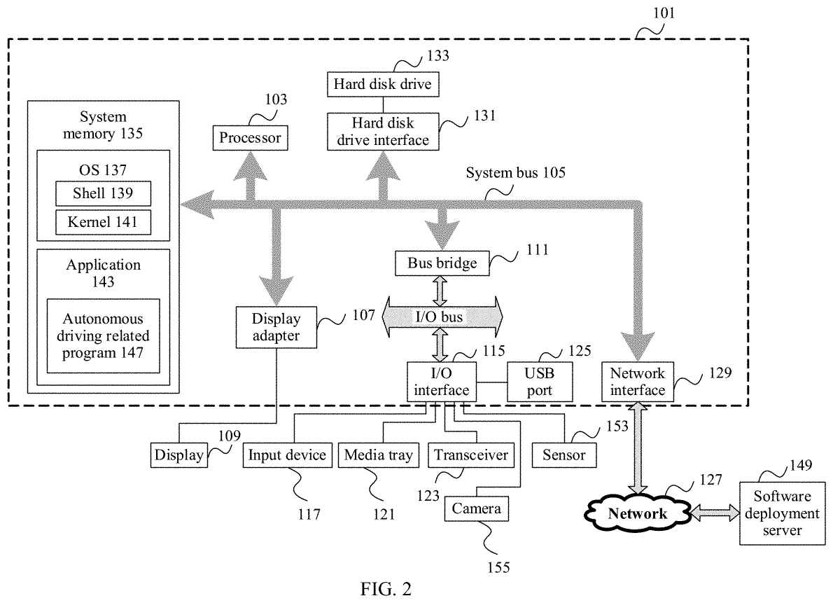

A ranging method provided in the embodiments of this application may be applied to an autonomous driving system shown in FIG. 2. FIG. 2 is a schematic structural diagram of the autonomous driving system according to an embodiment of this application. According to FIG. 2, the autonomous driving system 101 includes a processor 103, and the processor 103 is coupled to a system bus 105. The processor 103 may be one or more processors, and each processor may include one or more processor cores. A display adapter (video adapter) 107 may drive a display 109, and the display 109 is coupled to the system bus 105. The system bus 105 is coupled to an input/output (I/O) bus 113 through a bus bridge 111. An I/O interface 115 is coupled to the I/O bus. The I/O interface 115 communicates with a plurality of I/O devices, such as an input device 117 (for example, a keyboard, a mouse, or a touchscreen), a multimedia compact disc (CD) (media tray) 121 (for example, a CD read-only memory (ROM) (CD-ROM) or a multimedia interface), a transceiver 123 (which may send and/or receive a radio communication signal), a camera 155 (which may capture static and dynamic digital video pictures), and an external Universal Serial Bus (USB) port 125. Optionally, an interface connected to the I/O interface 115 may be a USB port.

The processor 103 may be any conventional processor, including a reduced instruction set computing (RISC) processor, a complex instruction set computing (CISC) processor, or a combination thereof. Optionally, the processor may be a dedicated apparatus such as an application-specific integrated circuit (ASIC). Optionally, the processor 103 may be a neural-network processing unit or a combination of a neural-network processing unit and the foregoing conventional processor.

Optionally, in the embodiments described in this specification, the autonomous driving system 101 may be located far away from an autonomous driving vehicle, and may perform wireless communication with the autonomous driving vehicle. In other aspects, some processes described in this specification are performed on a processor disposed inside the autonomous driving vehicle, and others are performed by a remote processor, including taking actions for performing a single operation.

The autonomous driving system 101 may communicate with a software deployment server 149 by using a network interface 129. The network interface 129 is a hardware network interface, for example, a network interface card. A network 127 may be an external network, such as the Internet, or may be an internal network, such as the Ethernet or a virtual private network (VPN). Optionally, the network 127 may alternatively be a wireless network, for example, a WI-FI network or a cellular network.

A hard disk drive interface is coupled to the system bus 105. The hardware drive interface is connected to a hard disk drive. A system memory 135 is coupled to the system bus 105. Data running in the system memory 135 may include an operating system 137 and an application 143 of a computer 101.

The operating system includes a shell 139 and a kernel 141. The shell 139 is an interface between a user and the kernel of the operating system. The shell is the outermost layer of the operating system. The shell manages interaction between the user and the operating system: waiting for input of the user, explaining the input of the user to the operating system, and processing various output results of the operating system.

The kernel 141 includes components of the operating system that are configured to manage a memory, a file, a peripheral, and a system resource. The kernel 141 directly interacts with hardware. The kernel of the operating system usually runs processes, provides inter-process communication, and provides central processing unit (CPU) time slice management, interruption, memory management, I/O management, and the like.

The application 141 includes a program related to controlling autonomous driving of a vehicle, for example, a program for calculating a distance between the vehicle and an obstacle on a road, a program for managing interaction between an autonomous driving vehicle and an obstacle on a road, a program for controlling a route or speed of an autonomous driving vehicle, or a program for controlling interaction between an autonomous driving vehicle and another autonomous driving vehicle on a road. The application 141 also exists on a system of the software deployment server 149. In an embodiment, when the application 141 needs to be executed, the computer system 101 may download the application 141 from the software deployment server 149.

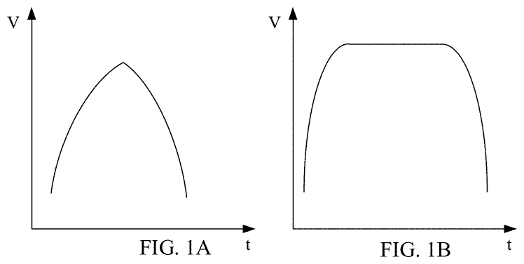

In the conventional technology, for a common laser ranging system such as a laser radar, when a requirement of long-distance ranging is met, a case in which an echo signal is saturated usually occurs in a process of measuring a short distance. The reason for this case is as follows. In a laser ranging system, when a received laser signal is converted into an electrical signal such as a voltage signal, the laser signal may be converted into a voltage within a specific range, such as a voltage within a range of 0 to 5 V. For example, when a trans-impedance amplifier (TIA) is used to convert the laser signal into the electrical signal, or when an analog-to-digital converter (ADC) is used to quantize an analog electrical signal into a digital signal, the TIA and the ADC each have an allowed input voltage range, for example, a voltage range of 0- to 5 volts (V). However, when the requirement of long-distance ranging is met, parameters for transmitting a laser pulse by the common laser ranging system need to meet the requirement of long-distance ranging, for example, a transmit power needs to be relatively large. However, for a short distance, if a laser pulse is transmitted at the transmit power, because the distance is relatively short, power loss in the laser pulse transmission process is relatively small. Correspondingly, a voltage value corresponding to a reflected echo signal may be relatively large. For example, a range of the voltage value corresponding to the reflected echo signal is 0 to 7 V, but a convertible voltage range of the laser ranging system is 0 to 5 V. Therefore, during short distance ranging, a part whose voltage value is greater than 5 V in the echo signal is converted into a voltage of 5 V. As a result, a waveform “clipped” case shown in FIG. 1B occurs.

In the conventional technology, when a receiving moment of the echo signal is determined, an amplitude value such as a voltage of the echo signal may be used to determine the receiving moment of the echo signal. For example, a moment corresponding to a maximum voltage in the echo signal may be determined as the receiving moment of the echo signal. For another example, a center of mass of the echo signal may be determined as the receiving moment of the echo signal. It may be understood that for a manner in which “a moment corresponding to a maximum voltage in the echo signal may be determined as the receiving moment of the echo signal”, due to a waveform “clipped” case of a saturated echo signal, the moment corresponding to the maximum voltage cannot be accurately determined, that is, the receiving moment of the saturated echo signal cannot be determined. For a manner in which “a center of mass of the echo signal may be determined as the receiving moment of the echo signal”, because an actual voltage value of a “clipped” part of the saturated echo signal cannot be determined, the center of mass of the saturated echo signal also cannot be accurately calculated, that is, the receiving moment of the saturated echo signal cannot be accurately determined. Consequently, a ranging result is inaccurate.

Moreover, the pulse width of the saturated echo signal may be broadened to affect an echo waveform, and a time walk error caused by an incomplete echo characteristic and a waveform change makes it difficult to accurately determine the receiving moment of the echo signal. A conventional time discrimination method such as peak discrimination or leading edge detection may cause a relatively large time walk error and also reduce ranging accuracy.

It may be understood that, during actual application, if a hardware circuit for converting an optical signal into an electrical signal in the laser ranging system is improved, and a range of voltage that is converted from a laser signal is expanded, for example, the foregoing voltage range of 0 to 5 V is expanded to a voltage range of 0 to 10 V, the foregoing problem that the receiving moment of the saturated echo signal cannot be accurately determined may be resolved. However, costs for improving the hardware circuit are relatively high. In view of this, an embodiment of this application provides a ranging method, so that a hardware circuit may not need to be improved, and a measured distance between a measured object and a laser can be accurately determined even if an echo signal is saturated.

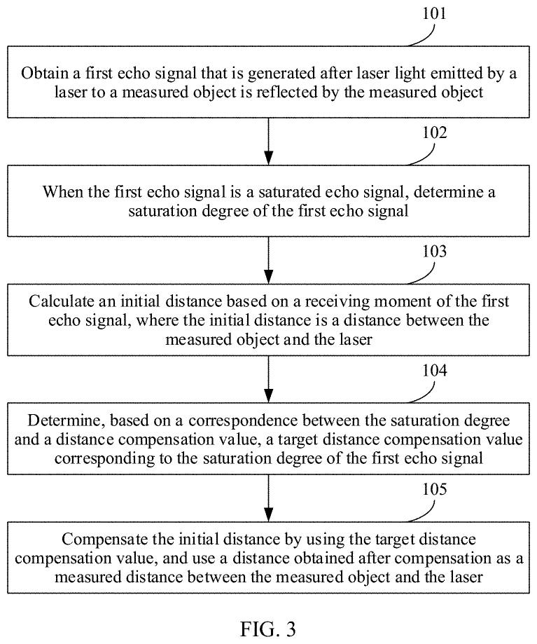

FIG. 3 is a flowchart of a ranging method according to an embodiment of this application. The ranging method provided in this embodiment of this application may be performed by a controller. The controller may be a digital signal processing (DSP) chip or the like. This is not limited in this embodiment of this application. The method may be implemented by using the following steps 101 to 105.

Step 101: Obtain a first echo signal that is obtained after laser light emitted by a laser to a measured object is reflected by the measured object.

In this embodiment of this application, when ranging is performed on the measured object, a laser pulse emitted by the laser is reflected back by the measured object, and then is received by a receive end of a laser ranging system. The receive end converts a laser light signal into an electrical signal, and the electrical signal is the first echo signal.

The measured object is not limited in this embodiment of this application, and the measured object may be an object capable of reflecting a laser pulse.

In this embodiment of this application, the pulse emitted by the laser may be any one of a Gaussian pulse, a sine wave, and a square wave. The laser may be a laser in the laser ranging system, or may be a ToF depth camera laser. This is not limited in this embodiment of this application.

For each pixel in a receiving field of view of the laser ranging system, after the laser emits the laser pulse, the receive end receives an analog electrical signal within a period of time (this period of time is determined by a maximum distance measurement range of the laser ranging system). In this embodiment of this application, the analog electrical signal or a data signal that is obtained through sampling by an ADC is referred to as a full waveform echo signal. The full waveform echo signal includes the first echo signal corresponding to the measured object, and may also include an echo signal corresponding to another object. In this embodiment of this application, during specific implementation of step 101, the full waveform echo signal may be first obtained, and then the first echo signal is extracted from the full waveform echo signal. Further, the first echo signal may be a sampling point set in the full waveform echo signal, and in the sampling point set, there is a point whose amplitude value is greater than or equal to a first threshold. For example, an amplitude value of a point whose amplitude value is the largest in the sampling point set is greater than or equal to the first threshold.

A specific value of the first threshold is not limited in this embodiment of this application. In an implementation of this embodiment of this application, for example, the specific value of the first threshold may be determined based on a false alarm threshold of the laser ranging system. It may be understood that generally, a part whose amplitude value is less than the false alarm threshold in the obtained first echo signal may be considered as noise. Therefore, in an implementation of this embodiment of this application, the first threshold may be equal to or close to the false alarm threshold.

The full waveform echo signal is not limited in this embodiment of this application. The full waveform echo signal may be a digital signal, or may be an analog signal. Amplitude values of a digital signal are non-consecutive in terms of time, and the digital signal may include discrete sampling points. Amplitude values of an analog signal are consecutive in terms of time. The first echo signal is not limited in this embodiment of this application. The first echo signal may be a digital signal, or may be an analog signal. It may be understood that when the first echo signal is the digital signal, the first echo signal may include a plurality of sampling points.

A method for obtaining the first echo signal is described below by using an example in which the full waveform echo signal is the digital signal.

First, a search range R=[a, b] may be initialized, where a is a left endpoint of the range R, and b is a right endpoint of the range R. Usually, initialization is performed to implement a=1, that is, a is the first sampling point, and b is a sampling point sequence number corresponding to a saturated distance threshold. Only when a distance between the measured object and the laser is less than the saturated distance threshold, the first echo signal corresponding to the measured object may be a saturated echo signal. A specific value of the saturated distance threshold may be less than or equal to the maximum distance measurement range of the laser ranging system. Subsequently, the search range R of the full waveform echo signal is searched for a first sampling point x whose amplitude value is greater than or equal to the first threshold. After the sampling point x is found, the point x may be used as a start point to select n points rightward, and a set of selected sampling points is the first echo signal. Alternatively, the search range R of the full waveform echo signal is searched for a first point y whose amplitude value is greater than or equal to the first threshold in a rising-edge-segment echo signal and a first point z whose amplitude value is less than or equal to the first threshold in a falling-edge-segment echo signal, and a set of sampling points selected by using y as a start point and z as an end point is the first echo signal. The rising-edge-segment echo signal is an echo signal whose general amplitude value changing trend is that an amplitude value increases as time increases, and the falling-edge-segment echo signal is an echo signal whose general amplitude value changing trend is that an amplitude value decreases as time increases.

Then, the left endpoint a of the search range R may be updated, where a=x+n+1, or a=z+1. The foregoing steps are repeated to search for a next first echo signal.

Step 102: When the first echo signal is a saturated echo signal, determine a saturation degree of the first echo signal.

In an implementation of this embodiment of this application, when a maximum amplitude value of the first echo signal is greater than or equal to a second threshold, and a quantity of saturated sampling points whose amplitude values are greater than or equal to the second threshold in the first echo signal is greater than or equal to a preset quantity, the first echo signal is the saturated echo signal.

Considering that generally an amplitude value of a saturated echo signal is relatively large in practice, in this embodiment of this application, whether the first echo signal is a saturated echo signal may be preliminarily determined based on the maximum amplitude value of the first echo signal. Further, when the maximum amplitude value of the first echo signal is greater than the second threshold, it may be considered that the amplitude value of the first echo signal is relatively large, and correspondingly, a possibility that the first echo signal is preliminarily determined as a saturated echo signal is relatively large.

As described above, the saturated echo signal may encounter a case such as a waveform “clipped” case or a pulse width broadening case. In this embodiment of this application, the quantity of saturated sampling points whose amplitude values are greater than or equal to the second threshold may be used to determine whether the first echo signal encounters waveform “clipped” or pulse width broadening. Generally, if no waveform “clipped” or pulse width broadening occurs in the first echo signal, the quantity of saturated sampling points whose amplitude values are greater than or equal to the second threshold is less than the preset quantity. Correspondingly, if the quantity of saturated sampling points whose amplitude values are greater than or equal to the second threshold is greater than or equal to the preset quantity, it may be determined that the first echo signal encounters waveform “clipped” or pulse width broadening. Therefore, it may be determined that the first echo signal is the saturated echo signal. In this embodiment of this application, an amplitude value corresponding to the second threshold is greater than an amplitude value corresponding to the first threshold. A specific value of the second threshold is not limited in this embodiment of this application. The second threshold may be an amplitude value less than or equal to an amplitude value corresponding to a “clipped” part of the saturated echo signal, and the amplitude value is also referred to as a saturation amplitude threshold. For example, the second threshold may be equal to the saturation amplitude threshold of the laser ranging system. For another example, the second threshold may be half of the saturation amplitude threshold. For another example, the second threshold may be three quarters of the saturation amplitude threshold.

In this embodiment of this application, the first echo signal may be analyzed to obtain the saturation degree of the first echo signal. As described above, the first echo signal may be a digital signal. When the first echo signal is a digital signal, during specific implementation, the saturation degree of the first echo signal may be determined based on the quantity of saturated sampling points whose amplitude values are greater than or equal to the second threshold in the first echo signal. It may be understood that, generally, a higher saturation degree of the first echo signal indicates a larger quantity of corresponding saturated sampling points whose amplitude values are greater than or equal to the second threshold, and a lower saturation degree of the first echo signal indicates a smaller quantity of corresponding saturated sampling points whose amplitude values are greater than or equal to the second threshold. In an implementation of this embodiment of this application, the saturation degree of the first echo signal is determined based on the quantity of saturated sampling points whose amplitude values are greater than or equal to the second threshold in the first echo signal. During specific implementation, the quantity of saturated sampling points may be determined as the saturation degree of the first echo signal. For example, if a quantity of points whose amplitude values are greater than or equal to the second threshold in the first echo signal is 3, a corresponding saturation degree of the first echo signal is 3.

During specific implementation, when a sampling rate of the ADC is relatively low, even if saturation degrees of two or more saturated echoes are different, it is difficult to differ the saturated echoes in a quantity of saturated sampling points. For this reason, a difference between saturation degrees of different saturated echoes may be amplified through interpolation. In this way, even if the difference between the saturation degrees of the different saturated echoes is small, the difference can be indicated by quantities of saturated sampling points.

Step 103: Calculate an initial distance based on a receiving moment of the first echo signal. The initial distance is a distance between the measured object and the laser.

A specific implementation of step 103 is not limited in this embodiment of this application. Two possible implementations are described below.

In an implementation of step 103, the receiving moment of the first echo signal and a transmitting moment of the first echo signal may be determined, and a difference between the receiving moment of the first echo signal and the transmitting moment of the first echo signal is calculated, to obtain a first time of flight of the laser light emitted by the laser between the laser and the measured object, and then the initial distance is obtained through calculation by using the first time of flight and a formula R=ct/2n. In the formula, R is the initial distance, c is a propagation speed of the light in the air, n is a refractive index of the light in a propagation medium, and t is the first time of flight. A specific implementation of determining the receiving moment of the first echo signal is not limited in this embodiment of this application. For example, the receiving moment of the first echo signal may be obtained by using a conventional manner of calculating a receiving moment of an echo signal. A specific implementation of determining the transmitting moment of the first echo signal is not limited in this embodiment of this application either. For example, a moment at which the laser emits the laser light to the measured object may be recorded, and the moment is determined as the transmitting moment of the first echo signal.

In another implementation of step 103, the initial distance may be determined by using a reference object whose actual distance from the laser is known. Further, the receiving moment of the first echo signal and a receiving moment of a second echo signal may be determined. The second echo signal is an echo signal obtained after laser light emitted by the laser to the reference object is reflected by the reference object. In this embodiment of this application, considering that in practice, the laser emits a plurality of beams of laser light to the reference object, theoretically, receiving moments of a plurality of echo signals obtained after the plurality of beams of laser light are reflected by the measured object are the same, and the laser light emitted by the laser to the reference object and the laser light emitted by the laser to the measured object may be a same beam of laser light, or may be two different beams of laser light. This is not limited in this embodiment of this application. In this embodiment of this application, a second time of flight of the laser light emitted by the laser between the measured object and the reference object may be obtained through calculation based on the receiving moment of the first echo signal and the receiving moment of the second echo signal, and then a distance between the measured object and the reference object is obtained through calculation by using the second time of flight and a formula R=ct/2n. In the formula, R is the distance between the measured object and the reference object, c is a propagation speed of the light in the air, n is a refractive index of the light in a propagation medium, and t is the second time of flight. Because the actual distance between the laser and the reference object is known, the initial distance may be obtained through calculation with reference to the known actual distance between the reference object and the laser and the distance between the measured object and the reference object. Further, if the reference object is located between the measured object and the laser, a sum of the known actual distance between the reference object and the laser and the distance between the measured object and the reference object may be calculated, to obtain the initial distance. Alternatively, if the measured object is located between the reference object and the laser, a difference between the known actual distance between the reference object and the laser and the distance between the measured object and the reference object may be calculated, to obtain the initial distance.

Step 104: Determine, based on a correspondence between the saturation degree and a distance compensation value, a target distance compensation value corresponding to the saturation degree of the first echo signal.

Step 105: Compensate the initial distance by using the target distance compensation value, and use a distance obtained after compensation as a measured distance between the measured object and the laser.

During actual application, ranging errors corresponding to the foregoing initial distance are different when saturation degrees of the first echo signal are different. Therefore, in this embodiment of this application, the target distance compensation value corresponding to the saturation degree of the first echo signal may be determined based on the saturation degree, and the target distance compensation value is used to compensate the initial distance, to obtain the measured distance between the measured object and the laser. Further, in this embodiment of this application, after the saturation degree of the first echo signal is determined in step 102, the target distance compensation value corresponding to the saturation degree of the first echo signal may be determined based on a prestored correspondence between a saturation degree and a distance compensation value. Subsequently, the target distance compensation value is added to the distance obtained through calculation, to obtain the measured distance between the measured object and the laser.

It can be learned that, according to the solutions in the embodiments of this application, the target distance compensation value suitable for the first echo signal may be determined based on the saturation degree of the first echo signal, to accurately determine the measured distance between the measured object and the laser.

As described above, a specific implementation of determining the receiving moment of the first echo signal is not limited in this embodiment of this application. However, it is considered that when the first echo signal is the saturated echo signal, the receiving moment of the first echo signal cannot be accurately determined by using a conventional manner of determining the first echo signal. Consequently, a ranging error corresponding to the initial distance that is obtained through calculation by using the receiving moment is relatively large. Therefore, in an implementation of this embodiment of this application, a new method is introduced and is used to accurately determine the receiving moment of the first echo signal, to reduce the ranging error corresponding to the foregoing initial distance. Further, it may be determined one or two corresponding moments at which an amplitude value is a first threshold. In addition, an earlier moment of the two moments is determined as the receiving moment of the first echo signal, or the one moment is determined as the receiving moment of the first echo signal.

During actual application, for the first echo signal, a start receiving moment of the first echo signal is almost unchanged regardless of whether the first echo signal is saturated or how much the saturation degree is. Therefore, in this embodiment of this application, if the first echo signal is the saturated echo signal, the start receiving moment of the first echo signal may be determined as the receiving moment of the first echo signal.

In this embodiment of this application, considering that the obtained first echo signal may include some noise, in this embodiment of this application, an earliest moment corresponding to a non-noise part of the first echo signal may be determined as the start receiving moment of the first echo signal. In this embodiment of this application, noise in the first echo signal and a valid echo signal may be distinguished by using the first threshold, to reduce noise interference. Further, a part whose amplitude value is less than the first threshold in the first echo signal may be determined as the noise. In other words, a part whose amplitude value is greater than or equal to the first threshold in the first echo signal is determined as the valid echo signal. Therefore, in this embodiment of this application, a corresponding moment at which an amplitude value is the first threshold may be first determined, and the start receiving moment of the first echo signal is determined based on the moment. It should be noted that generally, a waveform of a saturated echo signal is similar to that shown in FIG. 1B. When the amplitude value is the first threshold, that is, when a value of the vertical coordinate in FIG. 1B is equal to the first threshold, there may be one or two intersection points with the waveform of the saturated echo signal. In other words, when the amplitude value is the first threshold, there may be one or two corresponding moments. In this embodiment of this application, if there is one moment corresponding to the first threshold, it may be considered that the one moment is an initial receiving moment of the first echo signal. Alternatively, if there are two moments corresponding to the first threshold, it may be considered that an earlier moment of the two moments is an initial receiving moment of the first echo signal, and a later moment of the two moments is close to an end receiving moment of the first echo signal. Therefore, in this application, if there is one corresponding moment at which an amplitude value is equal to the first threshold in the first echo signal, the one moment is determined as the start receiving moment of the first echo signal, or if there are two corresponding moments at which an amplitude value is equal to the first threshold in the first echo signal, an earlier moment of the two moments is determined as the start receiving moment of the first echo signal.

As described above, the first echo signal mentioned in this embodiment of this application may be an analog signal, or may be a digital signal. It may be understood that when the first echo signal is an analog signal, and because the analog signal is consecutive in terms of time, the moment corresponding to the first threshold may be directly determined.

When the first echo signal is a digital signal, and because the digital signal is discrete sampling points, in these discrete sampling points, a sampling point whose amplitude value is the first threshold does not necessarily exist. Therefore, when the moment corresponding to the first threshold is to be determined, the moment corresponding to a sampling point whose amplitude value is closest to the first threshold may be determined as the moment corresponding to the first threshold.

It may be understood that, generally, the false alarm threshold is less than an amplitude value of the “clipped” part in the saturated echo signal. In other words, the first threshold is less than the amplitude value of the “clipped” part in the saturated echo signal. Therefore, by using the method provided in this embodiment of this application, the receiving moment of the first echo signal can be determined without considering the amplitude value of the “clipped” part in the saturated echo signal, different from the conventional technology in which the amplitude value of the “clipped” part in the saturated echo signal needs to be considered when the receiving moment of the saturated echo signal is determined. In addition, because the moment corresponding to the first threshold is closer to the start receiving moment of the first echo signal, the moment is relatively little affected by a waveform shape change brought by pulse width broadening, and a time walk error introduced by the waveform change can be reduced. Compared with that in the conventional technology, the determined receiving moment of the first echo signal is more accurate in the method provided in this embodiment of this application.

As described above, when the first echo signal is a digital signal, and because the digital signal is discrete sampling points, in these discrete sampling points, a sampling point whose amplitude value is the first threshold does not necessarily exist. Therefore, when the moment corresponding to the first threshold is to be determined, the moment corresponding to a sampling point whose amplitude value is closest to the first threshold may be determined as the moment corresponding to the first threshold. It may be understood that, because a sampling rate of a laser ranging system is relatively low, a time difference between two adjacent sampling points in the first echo signal is relatively large. In this case, a correspondingly determined receiving moment may also have a relatively large error. In this embodiment of this application, when the first echo signal is a digital signal, to improve a virtual sampling rate to reduce hardware implementation costs, and further to accurately determine the receiving moment of the first echo signal, the receiving moment of the first echo signal may be determined in a manner of calculating a rising edge equation.

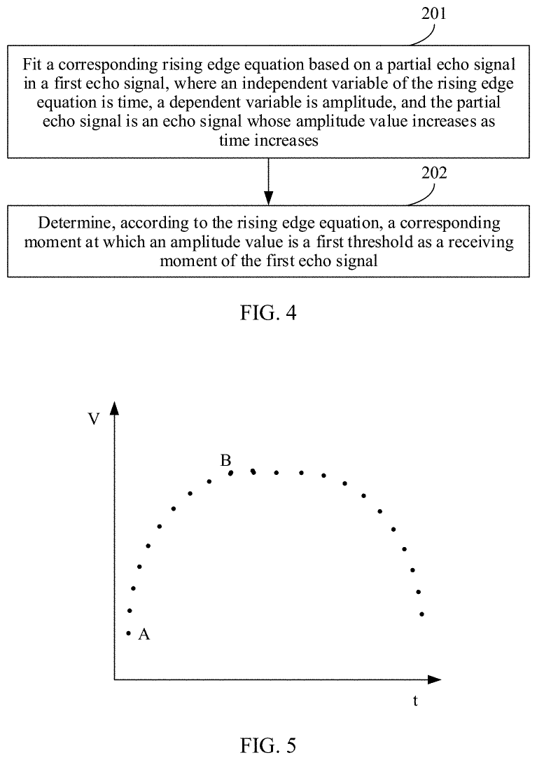

FIG. 4 is a schematic flowchart of determining a receiving moment of a first echo signal according to an embodiment of this application. The method may be implemented by using, for example, the following steps 201 and 202.

Step 201: Fit a corresponding rising edge equation based on a partial echo signal in a first echo signal, where an independent variable of the rising edge equation is time, a dependent variable is amplitude, and the partial echo signal is an echo signal whose amplitude value increases as time increases.

Step 202: Determine, according to the rising edge equation, a corresponding moment at which an amplitude value is a first threshold as a receiving moment of the first echo signal.

In this embodiment of this application, the rising edge equation of the first echo signal may be used to indicate, to some extent, a function relationship between the amplitude value of the partial echo signal in the first echo signal and time. The partial echo signal is an echo signal whose amplitude value increases as time increases. Further, for understanding, refer to FIG. 5. FIG. 5 is a schematic diagram of a first echo signal according to an embodiment of this application. The rising edge equation may be a function relationship obtained by using amplitudes and time of some or all sampling points from a sampling point A to a sampling point B in FIG. 5.

The following further describes methods for calculating a rising edge equation according to this embodiment of this application.

(1) Based on a curve shape of the partial echo signal, it is assumed that a curve equation of the partial echo signal is a function of a specific type (for example, a linear equation or a parabolic equation). Then, any plurality of sampling points whose amplitude values are greater than or equal to a first threshold in the partial echo signal are selected, where a quantity of the selected sampling points is determined by the type of the assumed function. For example, if it is assumed that the curve equation is the linear equation, any two sampling points may be selected, or if it is assumed that the curve equation is the parabolic equation, any three sampling points need to be selected. Finally, undetermined coefficients are solved by using an undetermined coefficient method, to obtain a function expression of the rising edge equation.

(2) A function expression of the rising edge equation is obtained through calculation by using a curve fitting method such as an interpolation method and a least square method based on all sampling points whose amplitude values are greater than or equal to a first threshold in the partial echo signal.

It may be understood that calculation in the method (1) is simple, calculation complexity of the method (2) is slightly higher than that of the method (1), but curve fitting accuracy of the method (2) is higher than that of the method (1). During actual application, it may be determined according to an actual situation that the calculation method (1) or the calculation method (2) is used to calculate the rising edge equation. If calculation complexity is used as a criterion, the method (1) may be used to calculate the rising edge equation. If accuracy is a main criterion, the method (2) may be used to calculate the rising edge equation.

In this embodiment of this application, after the rising edge equation of the first echo signal is determined, the moment corresponding to the first threshold may be determined as the receiving moment of the first echo signal according to the rising edge equation.

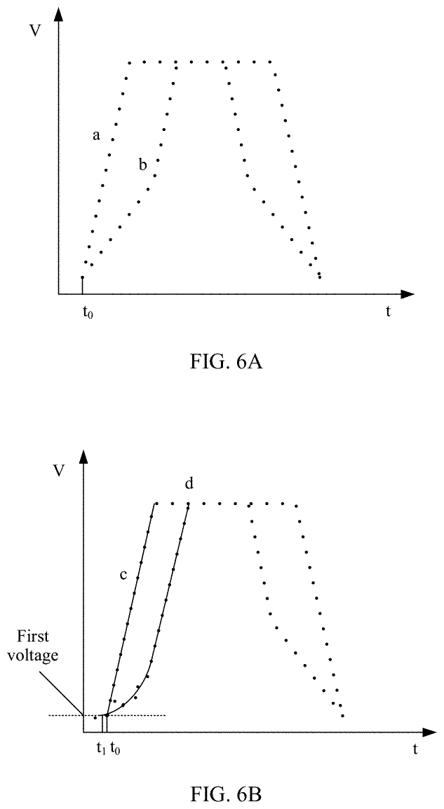

It should be noted that, during actual application, the receiving moment determined by using the rising edge equation is more accurate than the receiving moment determined by using the conventional technology. However, there may be some errors due to noise. Further, for understanding, refer to FIG. 6A and FIG. 6B. FIG. 6A is a schematic diagram of first echo signals with different saturation degrees according to an embodiment of this application. FIG. 6B is a schematic diagram of rising edge curves of first echo signals with different saturation degrees according to an embodiment of this application. For the first echo signals shown in FIG. 6A and FIG. 6B, actual start receiving moments of the first echo signals are all t₀. In FIG. 6A, a saturation degree of a first echo signal a is higher than a saturation degree of a first echo signal b. For the first echo signal a, sampling points whose amplitude values increase as time increases are almost on a same straight line and are less affected by noise. A rising edge curve (a curve corresponding to a rising edge equation is a curve c in FIG. 6B.) that is obtained through curve fitting passes through all sampling points, and therefore, curve fitting accuracy is relatively high. In this way, a receiving moment calculated by using a rising edge equation is almost equal to t₀. For the first echo signal b, noise affects a waveform of the foregoing partial echo signal, and further affects curve fitting accuracy. A rising edge curve that is obtained through curve fitting is a curve d in FIG. 6B. It can be learned that an error exists between the receiving moment obtained through calculation and t₀. Correspondingly, an error corresponding to an initial distance obtained through calculation by using the foregoing receiving moment is also relatively large. In a possible implementation, to reduce noise interference to improve curve fitting accuracy, when curve fitting is performed, some data sampling points may be deleted, for example, first p sampling points that are greater than or equal to a second voltage in the foregoing partial echo signal are deleted. A value of p is not further limited, and may be 2, 3, or 4. As described above, the correspondence between the saturation degree and the distance compensation value may be predetermined. In this embodiment of this application, a prestored correspondence between the saturation degree and the distance compensation value may be determined in a calibration manner.

Further, first, a laser may be used to emit a plurality of laser pulses to a calibration object whose actual distance from the laser is known, and then a plurality of calibration echo signals obtained by converting a plurality of laser signals reflected back by the calibration object are obtained, where the plurality of calibration echo signals are all digital signals. In this embodiment of this application, for example, calibration echo signals with various saturation degrees can be obtained in a manner of adjusting a transmit power of the laser, a reflectance, an amplification coefficient of automatic gain control (AGC), or an amplification coefficient of a variable gain amplifier (VGA). Alternatively, when factors such as the transmit power, the calibration object, or the VGA/AGC amplification coefficient remain unchanged, a plurality of saturated echo signals with different degrees are obtained by adjusting the known actual distance between the calibration object and the laser.

Then, a saturation degree of each calibration echo signal is estimated. For example, a quantity of saturated sampling points whose amplitude values are greater than or equal to the second threshold in each calibration signal is determined as the saturation degree of each calibration echo signal, to obtain num₁, num₂, . . . , numₖ, . . . , num_{N}, where numₖ is a saturation degree of the k^{th} calibration echo signal, and N is a quantity of the calibration echo signals.

Then, a rising edge equation of each calibration echo signal in the plurality of calibration echo signals is calculated by using the method of calculating the rising edge equation, and according to the rising edge equation corresponding to each of the plurality of calibration echo signals, a corresponding moment at which an amplitude value of each of the plurality of calibration echo signals is the first threshold is determined as a receiving moment of each of the plurality of calibration echo signals, and a distance between the calibration object and the laser is calculated by using the receiving moment of each of the plurality of calibration echo signals, to obtain a calculated distance corresponding to each of the plurality of calibration echo signals.

Then, differences between a known actual distance between the calibration object and the laser and the plurality of calculated distances are separately calculated, to obtain a plurality of distance compensation values in calibration σ₁, σ₂, . . . , σₖ, . . . , σ_{N}, where σₖ is a distance compensation value corresponding to the k^{th} calibration echo signal.

Finally, the correspondence is determined based on each distance compensation value in the plurality of distance compensation values in calibration and a saturation degree corresponding to each distance compensation value. That is, the correspondence is determined based on a distance compensation value σₖ corresponding to a k^{th} calibration echo signal and a saturation degree numₖ of the k^{th} calibration echo signal.

In this embodiment of this application, a correspondence between the saturation degree numₖ of the k^{th} calibration echo signal and the distance compensation value in calibration σₖ (k=1, 2, . . . , N) corresponding to the k^{th} calibration echo signal may be stored. In this embodiment of this application, the correspondence may be converted into a look-up table or a function expression.

Based on the ranging method provided in the foregoing embodiments, the embodiments of this application further provide a corresponding ranging apparatus and a ranging device. The ranging apparatus and the ranging device is described below with reference to the accompanying drawings.

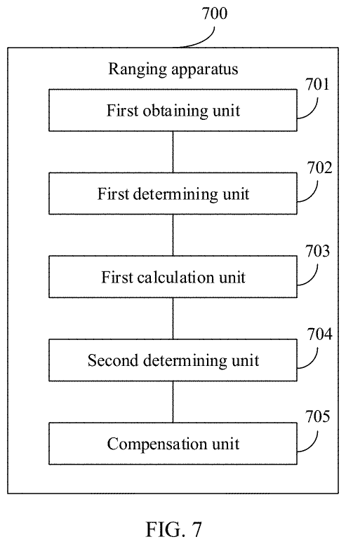

FIG. 7 is a schematic structural diagram of a ranging apparatus according to an embodiment of this application. The ranging apparatus 700 shown in FIG. 7 includes a first obtaining unit 701, a first determining unit 702, a first calculation unit 703, a second determining unit 704, and a compensation unit 705, where the first obtaining unit 701 is configured to obtain a first echo signal that is obtained after laser light emitted by a laser to a measured object is reflected by the measured object, the first determining unit 702 is configured to, when the first echo signal is a saturated echo signal, determine a saturation degree of the first echo signal, the first calculation unit 703 is configured to calculate an initial distance based on a receiving moment of the first echo signal, where the initial distance is a distance between the measured object and the laser, the second determining unit 704 is configured to determine, based on a correspondence between the saturation degree and a distance compensation value, a target distance compensation value corresponding to the saturation degree of the first echo signal, and the compensation unit 705 is configured to compensate the initial distance by using the target distance compensation value, and use a distance obtained after compensation as a measured distance between the measured object and the laser.

In a possible implementation, the apparatus further includes a third determining unit configured to determine one or two corresponding moments at which an amplitude value of the first echo signal is a first threshold, and determine an earlier moment of the two moments or the one moment as the receiving moment of the first echo signal, where a part whose amplitude value is less than the first threshold in the first echo signal is noise.

In a possible implementation, the first echo signal is a digital signal, and the third determining unit is further configured to fit a corresponding rising edge equation based on a partial echo signal in the first echo signal, where an independent variable of the rising edge equation is time, a dependent variable is amplitude, and the partial echo signal is an echo signal whose amplitude value increases as time increases, and determine, according to the rising edge equation, a corresponding moment at which the amplitude value is the first threshold as the receiving moment of the first echo signal.

In a possible implementation, the apparatus further includes a second obtaining unit configured to obtain a plurality of calibration echo signals, where each of the plurality of calibration echo signals corresponds to one saturation degree, the plurality of calibration echo signals are obtained after laser light emitted by the laser to a calibration object is reflected by the calibration object, and all the plurality of calibration echo signals are digital signals, a second calculation unit configured to calculate a corresponding rising edge equation for each of the plurality of calibration echo signals, a fourth determining unit configured to determine, according to the rising edge equation corresponding to each of the plurality of calibration echo signals, a corresponding moment at which an amplitude value of each of the plurality of calibration echo signals is the first threshold as a receiving moment of each of the plurality of calibration echo signals, a third calculation unit configured to calculate a distance between the calibration object and the laser by using the receiving moment of each of the plurality of calibration echo signals, to obtain a calculated distance corresponding to each of the plurality of calibration echo signals, a fourth calculation unit configured to separately calculate differences between a known actual distance between the calibration object and the laser and the plurality of calculated distances, to obtain a plurality of distance compensation values in calibration, and a fifth determining unit configured to determine the correspondence based on each distance compensation value in the plurality of distance compensation values in calibration and a saturation degree corresponding to each distance compensation value.

In a possible implementation, the first echo signal includes a plurality of sampling points, and determining a saturation degree of the first echo signal includes determining, in the plurality of sampling points, the saturation degree of the first echo signal based on a quantity of saturated sampling points whose amplitude values are greater than or equal to a second threshold in the first echo signal, where the saturation degree is positively correlated with the quantity of saturated sampling points, and an amplitude value corresponding to the second threshold is greater than an amplitude value corresponding to the first threshold.

In a possible implementation, that the first echo signal is a saturated echo signal includes, when a maximum amplitude value of the first echo signal is greater than or equal to the second threshold, and the quantity of saturated sampling points whose amplitude values are greater than or equal to the second threshold in the first echo signal is greater than or equal to a preset quantity, the first echo signal is the saturated echo signal.

In a possible implementation, the first calculation unit 703 is further configured to obtain, based on the receiving moment of the first echo signal and a transmitting moment of the first echo signal, a first time of flight of the laser light emitted by the laser between the laser and the measured object, and obtain the initial distance through calculation based on the first time of flight.

In a possible implementation, the first calculation unit 703 is further configured to obtain, based on the receiving moment of the first echo signal and a receiving moment of a second echo signal, a second time of flight of the laser light emitted by the laser between the measured object and a reference object, where the second echo signal is an echo signal obtained after the laser light emitted by the laser to the reference object is reflected by the reference object, obtain a distance between the measured object and the reference object through calculation based on the second time of flight, and calculate a sum of a known actual distance between the reference object and the laser and the distance between the measured object and the reference object, to obtain the initial distance, or calculate a difference between a known actual distance between the reference object and the laser and the distance between the measured object and the reference object, to obtain the initial distance.

Because the apparatus 700 is an apparatus corresponding to the ranging method provided in the foregoing method embodiments, a specific implementation of each unit in the apparatus 700 is a same concept as that in the foregoing method embodiments. Therefore, for the specific implementation of each unit in the apparatus 700, refer to the description parts of the ranging method in the foregoing method embodiments. Details are not described herein again.

An embodiment of this application further provides a ranging device. The device includes a processor and a memory.

The memory is configured to store instructions.

The processor is configured to execute the instructions in the memory, to perform the ranging method provided in the foregoing method embodiments.

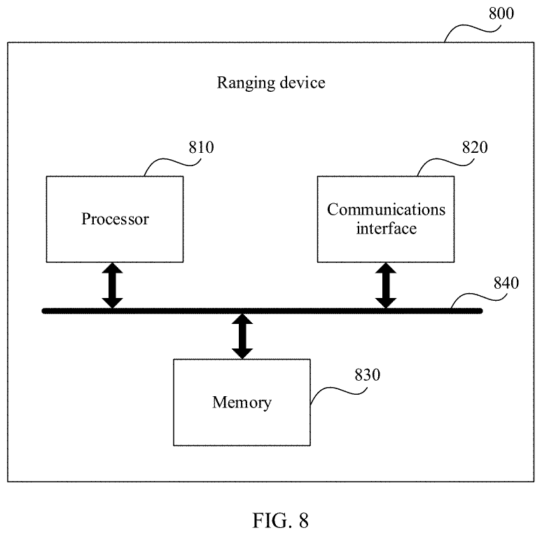

It should be noted that the ranging device in this embodiment of this application may use a hardware structure shown in FIG. 8. FIG. 8 is a schematic structural diagram of a ranging device according to an embodiment of this application.

As shown in FIG. 8, the ranging device 800 includes a processor 810, a communications interface 820, and a memory 830. There may be one or more processors 810 in the ranging device 800, and FIG. 8 shows one processor as an example. In this embodiment of this application, the processor 810, the communications interface 820, and the memory 830 may be connected by using a bus system or in another manner, and are connected through a bus system 840 as an example in FIG. 8.

The processor 810 may be a CPU, a network processor (NP), or a combination of the CPU and the NP. The processor 810 may further include a hardware chip. The hardware chip may be an ASIC, a programmable logic device (PLD), or a combination thereof. The PLD may be a complex PLD (CPLD), a field-programmable gate array (FPGA), generic array logic (GAL), or any combination of the CPLD and the FPGA.

The memory 830 may include a volatile memory, for example, a random-access memory (RAM). The memory 830 may alternatively include a non-volatile memory, for example, a flash memory, a hard disk drive (HDD), or a solid-state drive (SSD). The memory 830 may further include a combination of the foregoing types of memories.

The memory 830 may store, in the memory 830, the correspondence between the saturation degree and the distance compensation value in the foregoing embodiments.

Optionally, the memory 830 stores an operating system and a program, an executable module, or a data structure, or a subset thereof, or an extended set thereof. The program may include various operation instructions used to implement various operations. The operating system may include various system programs, to implement various basic services and process hardware-based tasks. The processor 810 may read the program in the memory 830, to implement the ranging method provided in this embodiment of this application.

The bus system 840 may be a Peripheral Component Interconnect (PCI) bus, an Extended Industry Standard Architecture (EISA) bus, or the like. The bus system 840 may be classified into an address bus, a data bus, a control bus, and the like. For ease of representation, only one thick line is used to represent the bus in FIG. 8, but this does not mean that there is only one bus or only one type of bus.

It should be noted that, when the ranging device in FIG. 8 is used in the autonomous driving system in FIG. 2, the processor 810 in FIG. 8 may be equivalent to the processor 103 in FIG. 2. The communications interface 820 in FIG. 8 may be equivalent to the bus bridge 111 in FIG. 2. The memory 830 in FIG. 8 may be equivalent to the system memory 135 in FIG. 2. The system bus 840 in FIG. 8 is equivalent to the system bus 105 in FIG. 2.

It should be noted that, the ranging device in FIG. 8 may be also used in another system different from the autonomous driving system shown in FIG. 2, and details are not described herein again.

An embodiment of this application further provides a computer-readable storage medium, including instructions. When the instructions are run on a computer, the computer is enabled to perform the ranging method according to the method embodiments.

An embodiment of this application further provides a computer program product including instructions. When the computer program product is run on a computer, the computer is enabled to perform the ranging method according to the method embodiments. It may be clearly understood by persons skilled in the art that, for the purpose of convenient and brief description, for a detailed working process of the foregoing system, apparatus, and unit, refer to a corresponding process in the foregoing method embodiments, and details are not described herein again.

An embodiment of this application further provides a mobile platform. The mobile platform includes a laser, a receiver, and the ranging apparatus 700 according to the foregoing embodiments. The laser is configured to emit laser light to a measured object, and the receiver is configured to receive an echo signal formed through reflection by the measured object. The ranging apparatus 700 is configured to obtain a distance between the measured object and the laser based on the echo signal received by the receiver.

In the several embodiments provided in this application, it should be understood that the disclosed system, apparatus, and method may be implemented in other manners. For example, the described apparatus embodiments are merely examples. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected based on actual requirements to achieve the objectives of the solutions of the embodiments.

In addition, function units in the embodiments of this application may be integrated into one processing unit, or each of the units may exist alone physically, or two or more units may be integrated into one unit. The integrated unit may be implemented in a form of hardware, or may be implemented in a form of a software function unit.

When the integrated unit is implemented in the form of a software function unit and sold or used as an independent product, the integrated unit may be stored in a computer-readable storage medium. Based on such an understanding, the technical solutions of this application essentially, or the part contributing to the current technology, or all or a part of the technical solutions may be implemented in the form of a software product. The computer software product is stored in a storage medium and includes several instructions for instructing a computer device (which may be a personal computer, a server, a network device or the like) to perform all or a part of the steps of the methods described in the embodiments of this application. The foregoing storage medium includes any medium that can store program code, for example, a USB flash drive, a removable hard disk, a ROM, a RAM, a magnetic disk, or an optical disc.

In conclusion, the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of this application.

What is claimed is:

1. A ranging method comprising:
emitting, by a laser, a first laser light towards a measured object to reflect off the measured object as a first echo signal;
obtaining the first echo signal;
determining that the first echo signal is a saturated echo signal;
determining a first saturation degree of the first echo signal in response to determining that the first echo signal is the saturated echo signal;
calculating an initial distance based on a first receiving moment of the first echo signal, wherein the initial distance is between the measured object and the laser;
determining, based on a correspondence between the first saturation degree and a distance compensation value, a target distance compensation value corresponding to the first saturation degree;
compensating the initial distance using the target distance compensation value to obtain a first distance; and
setting the first distance as a measured distance between the measured object and the laser.

2. The ranging method of claim 1, wherein before calculating the initial distance, the ranging method further comprises:
determining one moment or two moments when a first amplitude value of the first echo signal is at a first threshold; and
determining an earlier moment of the two moments or the one moment as the first receiving moment, wherein a part of the first echo signal whose the first amplitude value is less than the first threshold is noise.

3. The ranging method of claim 2, wherein the first echo signal is a digital signal, and wherein the ranging method further comprises:
fitting a rising edge equation based on a partial echo signal in the first echo signal, wherein an independent variable of the rising edge equation is time, wherein a dependent variable of the rising edge equation is amplitude, and wherein the amplitude increases as the time increases; and
determining, according to the rising edge equation, a corresponding moment when the amplitude is at the first threshold as the first receiving moment.

4. The ranging method of claim 2, wherein before compensating the initial distance, the ranging method further comprises:
obtaining a plurality of calibration echo signals, wherein each of the calibration echo signals corresponds to a second saturation degree, wherein the calibration echo signals are reflected off of a calibration object, and wherein the calibration echo signals are digital signals;
calculating a corresponding rising edge equation for each of the calibration echo signals;
determining, according to the corresponding rising edge equation, a corresponding moment when a second amplitude value of each of the calibration echo signals is at the first threshold as a corresponding receiving moment of each of the calibration echo signals;
calculating a second distance between the calibration object and the laser using the corresponding receiving moment to obtain a calculated distance corresponding to each of the calibration echo signals;
separately calculating differences between a known actual distance that is between the calibration object and the laser and the calculated distances to obtain a plurality of distance compensation values in calibration; and
determining the correspondence based on each of the distance compensation values in calibration and a third saturation degree corresponding to each of the distance compensation values.

5. The ranging method of claim 2, wherein the first echo signal comprises a plurality of sampling points, and wherein the ranging method further comprises determining, in the sampling points, the first saturation degree based on a quantity of saturated sampling points comprising second amplitude values that are greater than or equal to a second threshold in the first echo signal, wherein the first saturation degree is positively correlated with the quantity of saturated sampling points, and wherein a third amplitude value corresponding to the second threshold is greater than a fourth amplitude value corresponding to the first threshold.

6. The ranging method of claim 5, further comprising:
determining that a maximum amplitude value of the first echo signal is greater than or equal to the second threshold;
determining that the quantity of saturated sampling points is greater than or equal to a preset quantity;
determining, in response to determining that the maximum amplitude value is greater than or equal to the second threshold and determining that the quantity of saturated sampling points is greater than or equal to the preset quantity, that the first echo signal is the saturated echo signal.

7. The ranging method of claim 1, further comprising:
obtaining, based on the first receiving moment and a transmitting moment of the first echo signal, a time of flight (ToF) of the first laser light between the laser and the measured object; and
obtaining the initial distance through calculation based on the ToF.

8. The ranging method of claim 1, further comprising:
obtaining, based on the first receiving moment and a second receiving moment of a second echo signal, a time of flight (ToF) of a second laser light between the measured object and a reference object, wherein the second echo signal is obtained when the second laser light is reflected off of the reference object;
obtaining a second distance between the measured object and the reference object through calculation based on the ToF; and
calculating a sum of a known actual distance that is between the reference object and the laser and the second distance to obtain the initial distance or calculating a difference between the known actual distance and the second distance to obtain the initial distance.

9. An apparatus comprising:
a processor; and
a non-transitory storage medium coupled to the processor and configured to store program instructions, wherein, when executed by the processor, the program instructions cause the apparatus to:
obtain a first echo signal, wherein a laser has emitted a first laser light towards a measured object to reflect off the measured object as the first echo signal;
determine that the first echo signal is a saturated echo signal;
determine a first saturation degree of the first echo signal in response to determining that the first echo signal is the saturated echo signal;
calculate an initial distance based on a first receiving moment of the first echo signal, wherein the initial distance is between the measured object and the laser;
determine, based on a correspondence between the first saturation degree and a distance compensation value, a target distance compensation value corresponding to the first saturation degree;
compensate the initial distance using the target distance compensation value to obtain a first distance; and
set the first distance as a measured distance between the measured object and the laser.

10. The apparatus of claim 9, wherein, when executed by the processor, the program instructions further cause the apparatus to:
determine one moment or two moments when a first amplitude value of the first echo signal is at a first threshold; and
determine an earlier moment of the two moments or the one moment as the first receiving moment, wherein a part of the first echo signal whose the first amplitude value is less than the first threshold is noise.

11. The apparatus of claim 10, wherein the first echo signal is a digital signal, and wherein, when executed by the processor, the program instructions further cause the apparatus to:
fit a rising edge equation based on a partial echo signal in the first echo signal, wherein an independent variable of the rising edge equation is time, wherein a dependent variable is amplitude, and wherein the amplitude increases as the time increases; and
determine, according to the rising edge equation, a corresponding moment when the amplitude is at the first threshold as the first receiving moment.

12. The apparatus of claim 10, wherein, when executed by the processor, the program instructions further cause the apparatus to:
obtain a plurality of calibration echo signals, wherein each of the calibration echo signals corresponds to a second saturation degree, wherein the calibration echo signals are reflected off of a calibration object, and wherein the calibration echo signals are digital signals;
calculate a corresponding rising edge equation for each of the calibration echo signals;
determine, according to the corresponding rising edge equation, a corresponding moment when a second amplitude value of each of the calibration echo signals is at the first threshold as a corresponding receiving moment of each of the calibration echo signals;
calculate a second distance between the calibration object and the laser using the corresponding receiving moment to obtain a calculated distance corresponding to each of the calibration echo signals;
separately calculate differences between a known actual distance that is between the calibration object and the laser and the calculated distances to obtain a plurality of distance compensation values in calibration; and
determine the correspondence based on each of the distance compensation values in calibration and a third saturation degree corresponding to each of the distance compensation values.

13. The apparatus of claim 10, wherein the first echo signal comprises a plurality of sampling points, and wherein, when executed by the processor, the program instructions further cause the apparatus to determine, in the sampling points, the first saturation degree based on a quantity of saturated sampling points comprising second amplitude values that are greater than or equal to a second threshold in the first echo signal, wherein the first saturation degree is positively correlated with the quantity of saturated sampling points, and wherein a third amplitude value corresponding to the second threshold is greater than a fourth amplitude value corresponding to the first threshold.

14. The apparatus of claim 13, wherein, when executed by the processor, the program instructions further cause the apparatus to:
identify that a maximum amplitude value of the first echo signal is greater than or equal to the second threshold;
identify that the quantity of saturated sampling points is greater than or equal to a preset quantity; and
determine, in response to identifying that the maximum amplitude value is greater than or equal to the second threshold and identifying that the quantity of saturated sampling points is greater than or equal to the preset quantity, that the first echo signal is the saturated echo signal.

15. The apparatus of claim 9, wherein, when executed by the processor, the program instructions further cause the apparatus to:
obtain, based on the first receiving moment and a transmitting moment of the first echo signal, a time of flight (ToF) of the first laser light between the laser and the measured object; and
obtain the initial distance through calculation based on the ToF.

16. The apparatus of claim 9, wherein, when executed by the processor, the program instructions further cause the apparatus to:
obtain, based on the first receiving moment and a second receiving moment of a second echo signal, a time of flight (ToF) of a second laser light between the measured object and a reference object, wherein the second echo signal is obtained when the second laser light is reflected off of the reference object;
obtain a second distance between the measured object and the reference object through calculation based on the ToF; and
calculate a sum of a known actual distance that is between the reference object and the laser and the second distance to obtain the initial distance or calculate a difference between the known actual distance and the second distance to obtain the initial distance.

17. A computer program product comprising computer-executable instructions that are stored on a non-transitory computer readable medium and that, when executed by a processor, cause an apparatus to:
obtain a first echo signal, wherein a laser has emitted a first laser light towards a measured object to reflect off the measured object as the first echo signal;
determine that the first echo signal is a saturated echo signal;
determine a first saturation degree of the first echo signal in response to determining that the first echo signal is the saturated echo signal;
calculate an initial distance based on a first receiving moment of the first echo signal, wherein the initial distance is between the measured object and the laser;
determine, based on a correspondence between the first saturation degree and a distance compensation value, a target distance compensation value corresponding to the first saturation degree;
compensate the initial distance using the target distance compensation value to obtain a first distance; and
set the first distance as a measured distance between the measured object and the laser.

18. The computer program product of claim 17, wherein before calculating the initial distance, the computer-executable instructions further cause the apparatus to:
determine one moment or two moments when a first amplitude value of the first echo signal is at a first threshold; and
determine an earlier moment of the two moments or the one moment as the first receiving moment, wherein a part of the first echo signal that the first amplitude value is less than the first threshold is noise.

19. The computer program product of claim 17, wherein the computer-executable instructions further cause the apparatus to:
obtain, based on the first receiving moment and a transmitting moment of the first echo signal, a time of flight (ToF) of the first laser light between the laser and the measured object; and
obtain the initial distance through calculation based on the ToF.

20. The computer program product of claim 17, wherein the computer-executable instructions further cause the apparatus to:
obtain, based on the first receiving moment and a second receiving moment of a second echo signal, a time of flight (ToF) of a second laser light between the measured object and a reference object, wherein the second echo signal is when the second laser light is reflected off of the reference object;
obtain a second distance between the measured object and the reference object through calculation based on the ToF; and
calculate a sum of a known actual distance that is between the reference object and the laser and the second distance to obtain the initial distance or calculate a difference between the known actual distance and the second distance to obtain the initial distance.
